(19) United States
(12) Patent Application Publication
(10) Pub. No.: US 2014/0061406 A1
(43) Pub. Date: Mar. 6, 2014

(54) SYSTEM FOR ATTACHING ACCESSORIES TO A MONITOR

(71) Applicants: Eddy Nelson Chevalier, Tampa, FL (US); Shevern Chasity Smith-Chevalier, Tampa, FL (US)

(72) Inventors: Eddy Nelson Chevalier, Tampa, FL (US); Shevern Chasity Smith-Chevalier, Tampa, FL (US)

(21) Appl. No.: 13/605,980

(22) Filed: Sep. 6, 2012

(51) Int. Cl. F16M 13/02

(52) U.S. Cl. 248/205.1

(57) ABSTRACT

A system permits various accessories to be attached to a computer monitor, allowing a user to save valuable desk space. The system of the present invention includes one or more accessory holders that can hold, for example, a cell phone, pens, eyeglasses, mirrors, photos, earphones, remote controls, photos, and the like. A user can choose which accessories they wish to mount on their monitor by purchasing one or more components of the system, saving time, money and complexity as compared to conventional multi-use systems.

### BACKGROUND OF THE INVENTION

The present invention relates to accessory organization devices and, more particularly, to a system for attaching accessories to a monitor.

People usually have limited desk space at work or on business travels. Current items for organizing desk and other accessories are cumbersome, unattractive and usually don't address specific needs.

The current items are either two-part systems or entire monitor assemblies, which are large and cumbersome for the average consumer to set up and use.

As can be seen, there is a need for an improved system for organizing desktop and other accessories.

### SUMMARY OF THE INVENTION

In one aspect of the present invention, a system for attaching accessories to a monitor comprises at least one accessory holder; and a base member of the accessory holder adapted to be attached to the monitor, wherein the at least one accessory holder is selected from the group consisting of a mobile phone holder, a pen/eyeglasses holder, a mirror holder, a photo holder, a lighting accessory, an ear phone holder and a remote control holder.

In another aspect of the present invention, a method for organizing a work space comprises providing at least one accessory holder on a monitor; disposing an accessory in the at least one accessory holder, wherein the accessory holder is selected from the group consisting of a mobile phone holder, a pen/eyeglasses holder, a mirror holder, a photo holder, a lighting accessory, an ear phone holder and a remote control holder.

In a further aspect of the present invention, a monitor-mounted accessory organization system comprises at least one accessory holder; a base member of the accessory holder adapted to be attached to the monitor; and a hinge allowing the accessory holder to pivot relative to the base member, wherein the at least one accessory holder is selected from the group consisting of a mobile phone holder, a pen/eyeglasses holder, a mirror holder, a photo holder, a lighting accessory, an ear phone holder and a remote control holder.

These and other features, aspects and advantages of the present invention will become better understood with reference to the following drawings, description and claims.

### BRIEF DESCRIPTION OF THE DRAWINGS

FIG. 1 is a perspective view of a desktop computer system having a cell phone holder mounted on a monitor according to an exemplary embodiment of the present invention;

FIG. 2 is a perspective view of a laptop computer system having a cell phone holder mounted on its monitor according to an exemplary embodiment of the present invention;

FIG. 3 is a detailed perspective view of the cell phone holder of FIGS. 1 and 2;

FIG. 4 is a detailed perspective view of the cell phone holder of FIGS. 1 and 2, showing rotation thereof;

FIG. 5 is a perspective view of a cell phone holder having a rear mounting bracket according to another embodiment of the present invention;

FIG. 6 is a side view of the cell phone holder of FIG. 5 attached to a wall;

FIG. 7 is a side view of a pen/glasses holding cup according to an exemplary embodiment of the present invention;

FIG. 8 is a perspective view of the pen/glasses holding cup of FIG. 7 attached to a monitor, showing rotation thereof;

FIG. 9 is a front view of a mirror holder according to an exemplary embodiment of the present invention;

FIG. 10 is a perspective view of the mirror holder of FIG. 9 attached to a monitor, showing rotation thereof;

FIG. 11 is a front view of a photo holder according to an exemplary embodiment of the present invention;

FIG. 12 is a perspective view of a photo holder of FIG. 11 attached to a monitor, showing rotation thereof;

FIG. 13 is a perspective view of a lighting accessory attached to a monitor according to an exemplary embodiment of the present invention;

FIG. 14 is a perspective view of an ear phone holder operable to be attached to a monitor according to an exemplary embodiment of the present invention;

FIG. 15 is a rear perspective view of a monitor having a TV remote control holder disposed on a rear side thereof;

FIG. 16 is a side view of the remote control holder of FIG. 15; and

FIG. 17 is a front view of the remote control holder of FIG. 15.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system permitting various accessories to be attached to a computer monitor, allowing a user to save valuable desk space. The system of the present invention includes one or more accessory holders that can hold, for example, a cell phone, pens, eyeglasses, mirrors, photos, earphones, remote controls, photos, and the like. A user can choose which accessories they wish to mount on their monitor by purchasing one or more components of the system, saving time, money and complexity as compared to conventional multi-use systems.

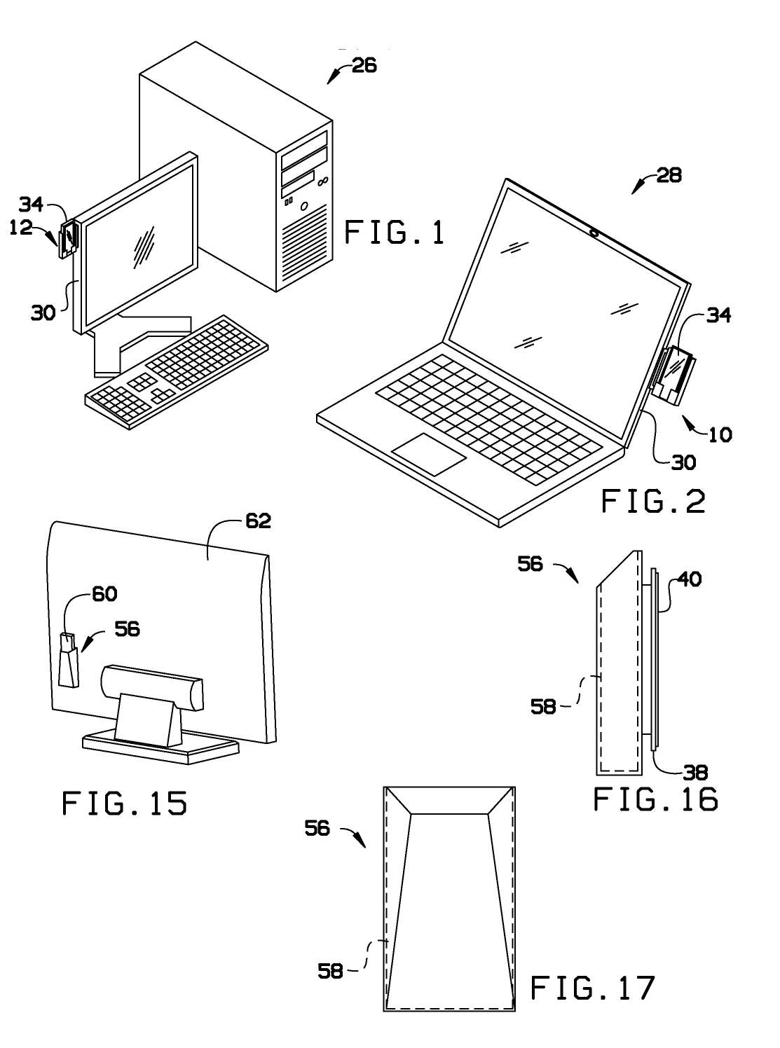

Referring to FIGS. 1 and 2, the system of the present invention can be used on various monitors 30, such as a monitor of a desktop computing system 26 or a laptop computing system 28. The system of the present invention can be applied to other components, such as walls and office furniture. The cell phone holder can be outfitted with open slots for charging access.

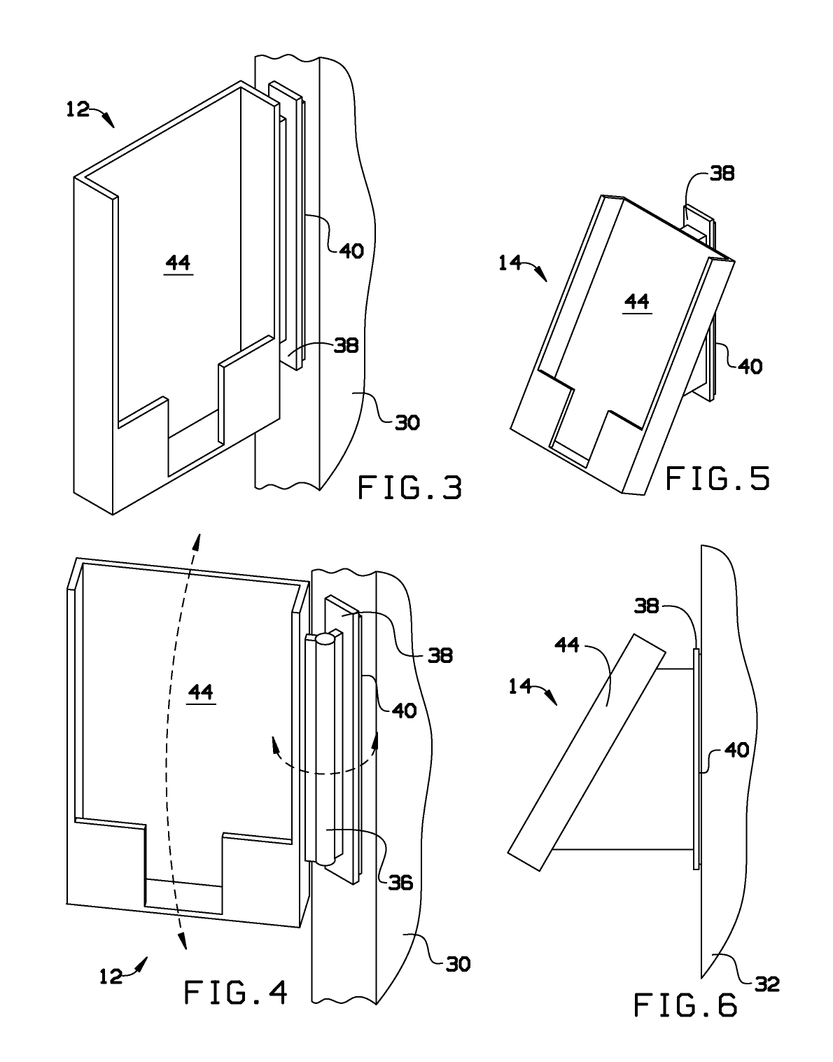

Referring now to FIGS. 1 through 4, a cell phone holder 12 can hold a cell phone 34 therewithin. The cell phone holder 12 can include a cell phone holding body 44 attached to a base 38 via a hinge 36. An adhesive 40 can be used to secure the cell phone holder 12 to the monitor 30. In some embodiments, the adhesive 40 can be a glue, double-sided tape, hook and loop fastener, or the like. The cell phone holder 12 can be designed to pivot and/or rotate about the hinge 36, as shown in FIG. 4.

In some embodiments, as shown in FIGS. 5 and 6, a rear mount cell phone holder 14 can be designed similar to the cell phone holder 12 of FIGS. 1 through 4, but with the base 38 disposed on a rear surface of the cell phone holding body 44, as opposed to a side wall of the cell phone holding body 44 as shown in FIGS. 1 through 4. The rear mount cell phone holder 14 can be disposed on a wall, in a car, on a monitor, on office furniture, or the like.

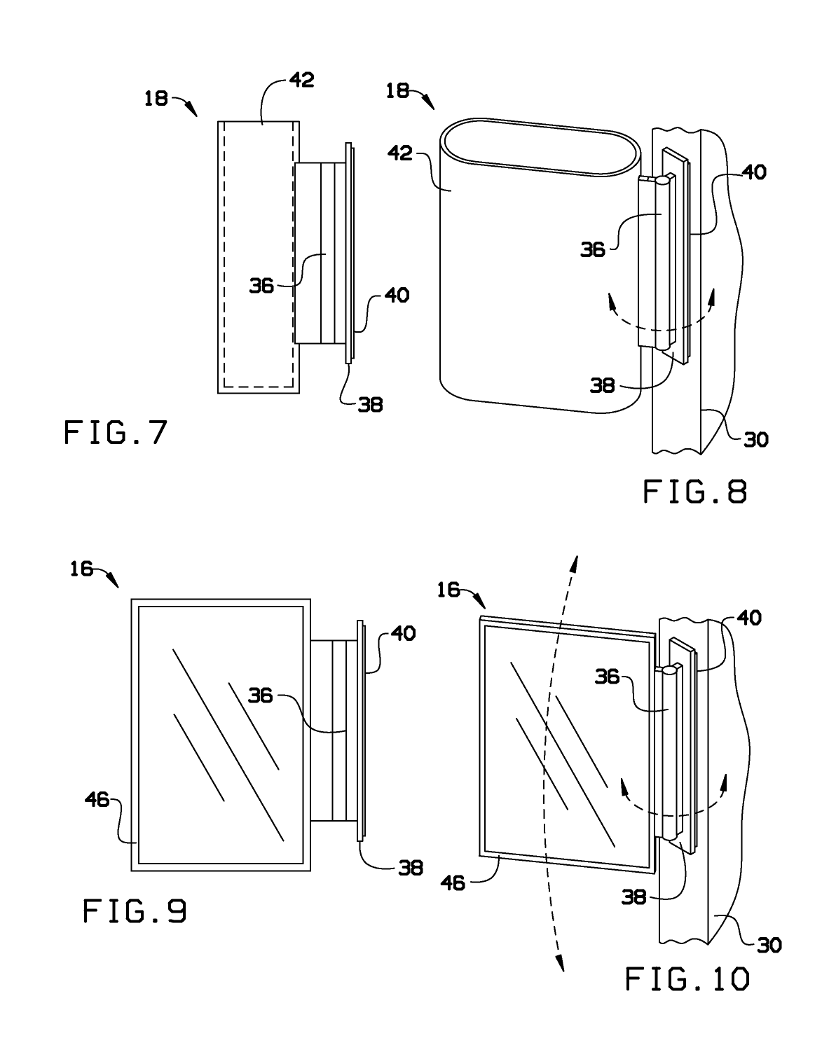

Referring to FIGS. 7 and 8, one accessory holder of the system of the present invention can include a pen/eyeglasses holding cup 18. The pen/eyeglasses holding cup 18 can includes a holding cup body 42 attached, via the hinge 36, to the base 38. The hinge 36 and base 38 can be designed similarly to that used in the cell phone holder 12 shown in FIGS. 1 through 4.

Referring now to FIGS. 9 and 10, a mirror holder 16 can be one of the accessory holders of the system of the present invention. The mirror holder 16 can include a mirror body 46 operable to hold a mirror. The mirror body 46 can be attached, via the hinge 36, to the base 38. The hinge 36 and base 38 can be designed similarly to that used in the cell phone holder 12 shown in FIGS. 1 through 4.

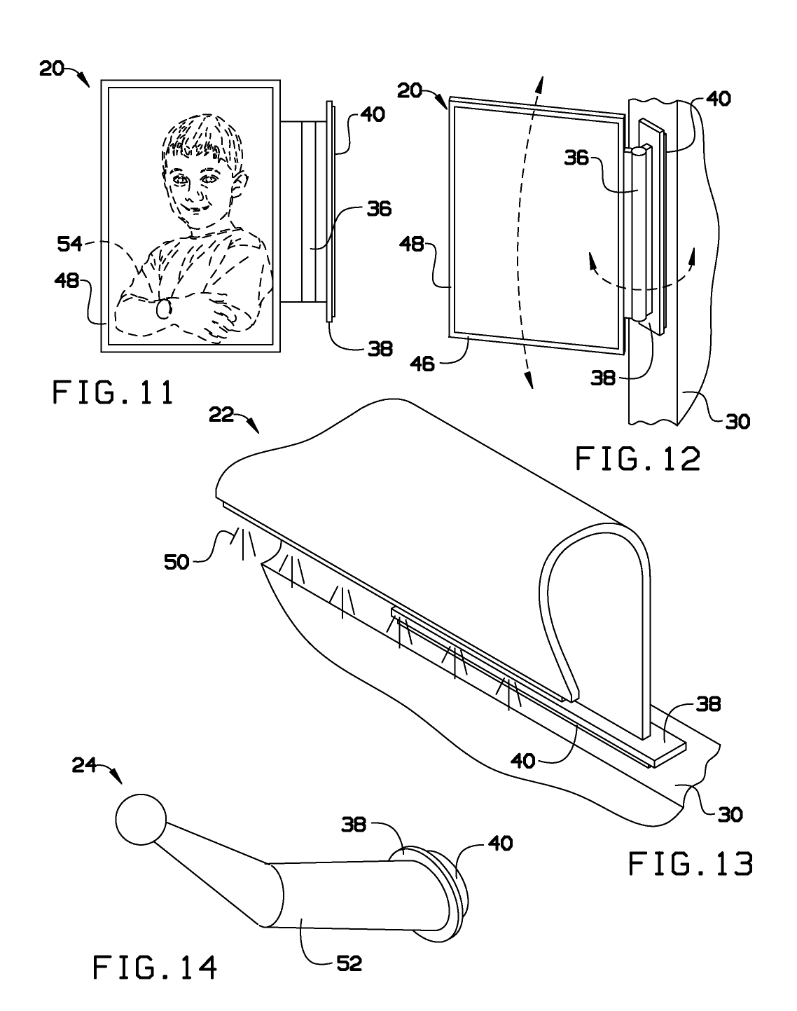

Referring now to FIGS. 11 and 12, a photo holder 20 can be one of the accessory holders of the system of the present invention. The photo holder 20 can include a photo holding body 48 operable to hold a mirror. The photo holding body 48 can be attached, via the hinge 36, to the base 38. The hinge 36 and base 38 can be designed similarly to that used in the cell phone holder 12 shown in FIGS. 1 through 4.

Referring to FIG. 13, a light assembly 22 can be one of the accessory holders of the system of the present invention. The light assembly 22 can direct light 50 in a desired direction. The light assembly 22 can be attached to the base 38. The base 38 can be designed similarly to that used in the cell phone holder 12 shown in FIGS. 1 through 4.

Referring to FIG. 14, an ear phone holder 24 can be one of the accessory holders of the system of the present invention. The ear phone holder 24 can include an earphone holding arm 52 to hold and support ear phones. The ear phone holder 24 can be attached to the base 38. The base 38 can be designed similarly to that used in the cell phone holder 12 shown in FIGS. 1 through 4.

Referring now to FIGS. 15 through 17, a remote control holder 56 can be designed with the base 38 similar to the base used in the cell phone holder shown in FIGS. 1 through 4, to allow the remote control holder 56 to be one of the accessory holders in the system of the present invention. The remote control holder 56 can include a remote control cavity 58 adapted to hold a remote control 60 therewithin. The remote control holder 56 can be designed to attach to a monitor or television 62, for example.

The system of the present invention can include one or more of the above described accessory holders, where the user can pick and choose which accessory holders are needed without having to purchase an entire system that can be cumbersome and not meet the user's specific needs.

It should be understood, of course, that the foregoing relates to exemplary embodiments of the invention and that modifications may be made without departing from the spirit and scope of the invention as set forth in the following claims.

1. A system for attaching accessories to a monitor comprising:
at least one accessory holder;
a base member directly supporting the at least one accessory holder, wherein
the base member of the accessory holder is adapted to be attached directly to the monitor, wherein
the at least one accessory holder is selected from the group consisting of a mobile phone holder, a pen/eyeglasses holder, a mirror holder, a photo holder, a lighting accessory, an ear phone holder and a remote control holder.

2. The system of claim 1, wherein the monitor is a laptop computer monitor.

3. The system of claim 1, wherein the monitor is a desktop computer monitor.

4. The system of claim 1, wherein the accessory holder includes a hinge allowing the accessory holder to pivot relative to the base member.

5. A method for organizing a work space, comprising:
providing at least one accessory holder directly attached to a monitor via a base member of the accessory holder;
disposing an accessory in the at least one accessory holder, wherein
the accessory holder is selected from the group consisting of a mobile phone holder, a pen/eyeglasses holder, a mirror holder, a photo holder, a lighting accessory, an ear phone holder and a remote control holder.

6. The method of claim 5, further comprising pivoting the accessory holder on a hinge to position the accessory holder in a desired position.

7. The method of claim 5, wherein the monitor is a laptop computer monitor.

8. The method of claim 5, wherein the monitor is a desktop computer monitor.

9. The method of claim 5, further comprising permitting a user to attach multiple accessory holders to the monitor to hold selected accessories.

10. A monitor-mounted accessory organization system comprising:
at least one accessory holder;
a base member directly supporting the at least one accessory holder, wherein the base member of the accessory holder adapted to be attached directly to the monitor; and
a hinge allowing the accessory holder to pivot relative to the base member, wherein
the at least one accessory holder is selected from the group consisting of a mobile phone holder, a pen/eyeglasses holder, a mirror holder, a photo holder, a lighting accessory, an ear phone holder and a remote control holder.
